(19) United States
(12) Patent Application Publication
(10) Pub. No.: US 2017/0300943 A1
(43) Pub. Date: Oct. 19, 2017

(54) DEVICE AND SYSTEM TO OBTAIN CUSTOMER FEEDBACK

(71) Applicant: Zeinolabedin Saadatfar, Richmond Hill (CA)

(72) Inventor: Zeinolabedin Saadatfar, Richmond Hill (CA)

(21) Appl. No.: 15/240,228

(22) Filed: Aug. 18, 2016

Related U.S. Application Data
(63) Continuation-in-part of application No. 15/130,024, filed on Apr. 15, 2016.

(51) Int. Cl. G06Q 30/02

(52) U.S. Cl. CPC G06Q 30/0203

(57) ABSTRACT

A device and method to obtain customer feedback about a service provider comprises of a simple device having a front side; with a plurality of inputs; an electronic display screen; a computer storage to store a set of survey question related to a particular product or a service. The device further contains of four input areas for the customer to provide the rating of the services or products. The method includes providing a customer with a ratings device that is capable of receiving feedback from a particular service provider by a personal card; percentage rating through electrical or mechanical buttons; voice input through a microphone and writing input through a text entry box and transmit the initial information to the management department of a service provider.

### RELATED APPLICATION

This application repeats a substantial portion of prior application Ser. No. 15/130,024 filed Apr. 15, 2016, and adds and claims additional disclosure not presented in the prior application. Since this application names the inventor or at least one joint inventor named in the prior application, it may constitute a continuation-in-part of the prior application.

### FIELD OF THE INVENTION

The present invention relates in general to customer feedback and in particular to a device and system for gathering customer feedback information.

### BACKGROUND OF THE INVENTION

Customer satisfaction is an important element of every company and organization. For this purpose and in order to improve their products and services, companies collect customer feedbacks. There are various ways to obtain customer feedback and to determine how satisfied the customers are. The most common way is through a customer feedback survey that asks participants to rank the company or the service provider. Studies show that service providers that score high in customer satisfaction grow faster than those who scored average or low.

A plurality elements effect on the progress of an organization. One of the ways to progress an organization is to collaborate with the employees and receive their feedback. Successful managers understand and anticipate the need for customers and employees satisfaction. They may meet regularly with employees to determine what actions are needed to improve customer's satisfaction in a timely, efficient and economical manner.

Customer feedback surveys offer the best and most accurate way to measure satisfaction. However, most of the surveys provide long questions that take several minutes or more to fill out, and ask lots of open-ended questions. Clients simply do not have the time for all that. Only 5-15% of the customers actually fill out the surveys and provide feedback. Most of these surveys are online, and usually only the customers who are not satisfy complete them. This results in a biased survey.

A method and a device that can provide a short and simple survey can encourage more customers to provide their feedback on the service provider, and encourage the employees to provide their feedback on the other employees, manager and the strategies of the company, store or organization. The data has shown that by using simple surveys, the rate of the response raises between 55-65%. Therefore, a simple and fast method results in more customer feedback.

There are various methods to measure customer satisfaction, such as surveys, phone calls, emails, online questions, etc. A variety of software to provide customer feedback measurements are also known. Organizations try to react to this feedback by improving their products and services to keep their customers satisfied. However, this can be challenging for an organization because of the many differences in customer feedback. Still, there is a need for a simple way to measure and collect valuable feedback of the customer to improve a service provider.

### SUMMARY OF THE INVENTION

The present invention provides a simple device and method for providing and obtaining customer feedback on a service provider, on a specific product or on a service. The device provides a simple method that each customer can leave feedback on an individual employee, as well as employees leaving feedbacks on each other. In addition, a manager can rate and evaluate the performance of the employees. A manager may seek customers' input and ask a set of questions through the feedback device to assess their satisfaction. The manager can share the results with the employees and develop action plans to improve customer relation.

The present feedback device is a box having a front side with a plurality of input buttons; an electronic display screen; a computer storage to store a set of survey questions related to a particular product or a service.

The first rating input is a slot mounted on the feedback device. The slot has a dimension of approximately 60 mm by 4 mm to receive a paper card or a chip card. The clients in an organization or a company, or customers in a store are able to provide their feedbacks on each employee or service provider that they have received a service, and rate it. Each case can be rated separately. Each customer receives a paper card or a chip card from the service provider. The service provider requests the customer to rate his/her service and drop the card into a slot on the feedback device.

The paper cards can be the size of a business card, and they have a Barcode, RFID or QR code with the name of each employee encrypted and coded thereon. Each of the employees in the company, in a store, or any service provider in an organization, receives their special card with a barcode. The feedback device comprises of a storage to store the information of the individual employees along with their photos. This quality prevents any mistake in providing feedback, whenever a customer refers to more than one employee and receives more than one card.

After the customer drops the card into the slot, the image and the name of the staff appears on the monitor of the device. A graph will then appear on the monitor with a rating from zero to 100% and the customer responses to it. Regarding to the setting of the device any rating question about a special service, a special product or other options is possible. After that a thank you phrase will appear on the monitor or will be heard by the microphone. Various thank you audio files or phrases can be set up on the device.

The present invention further has a scanning means to scan the barcodes on the cards that are associated to the specific employee or product. By scanning the barcode, the related information displays on the monitor and the participant can respond to the specific question and rate the product or employee. The information is gathered with the other data such as date, time and the location of the device.

A software application is installed on the rating device to program all these procedures. The device can be programmed to print various types of cards with the information thereon, by using Barcode or RFID, which can be printed on paper cards to give to the clients, employees or the manager.

The feedback device further comprises of a storage to store a set of survey question related to a particular product or a service.

The second feedback input comprises of eleven buttons rated from 0-100%, wherein each button represents the percentage of customer satisfaction. The input buttons may be electronic buttons or mechanical buttons. The customers can press one of the 11 keys of the rating device and a thank you phrase will appear on the monitor or a thank you voice will be heard from the system. The device will not accept another vote up to 5 seconds.

The third feedback input is a microphone for recording feedback from a participant. The customer can leave voice feedback by pressing the microphone button below the microphone. As soon as the customer presses the microphone button a phrase will appear on the monitor indicating that his/her voice will be recorded and heard by the manager. During this process colorful graphs will appear on the monitor. The customer will end the recording by pushing the microphone button.

The fourth feedback input is a text input box which is a touch screen display or an electronic paper adapted to receive a feedback and contact information of a customer. The customer can leave feedback by writing. The customer activates the writing display on the monitor and immediately a phrase will appear: “Please leave your message on the monitor screen with the stylus or finger nail and press the button. Your message will be sent”. At this time a thank you phrase will appear on the monitor. A monitor or an electronic LED, LCD display screen or other such facility is mounted on the feedback device to display information, a survey question, an announcement, a customized quote or the like.

Generally, the four input areas are capable of receiving feedback and transmitting the initial information to the management department of a service provider.

The feedback device further includes a random question generator to randomly select at least one survey question from a set of survey questions and to display selected question on a display screen.

A computer program is provided to collect the customer responses to each survey question, generate a database for all responses received from the customer and analyze all responses. Customer feedback is then transmitted to the service provider through a communication system.

Customer feedback device can be mounted in a place that is in view of the customer and is easily accessible. For example, the feedback device may be a tabletop customer feedback station, wall mount, floor mount, or mounted on a point of sale, point of transaction so customers can push the predetermined buttons or otherwise interact with the device to provide feedback for a specific product or service.

The customer feedback is then gathered and transmitted to the management department. Collection and transmission of the customer feedback allows management to intervene with a provided service when necessary.

The feedbacks will be collected and stored in a data structure associated with a network device and transmitted to one of the notification devices of the responsible persons. At least one of the responsible persons may be a manager.

The notification device for the present invention may be one of a phone, a SMS message, an email, a web page alert, a fax, a pager or other such facility. The service provider may be a grocery store, a restaurant, a hardware store, an electronic store, or a fitness center.

The feedback may be recorded through a microphone on the feedback device and then communicated to a network system and the information is then delivered to the appropriate person.

The feedback includes a communication facility for transmitting the customer feedback to a data processing facility, wherein the data processing facility delivers a message to a responsible person associated with the service provider. In the system, the communication facility may include a cell phone transmission facility, a pager transmission facility, a Wi-Fi transmission facility, or a Bluetooth transmission facility.

It is an object of the present invention to provide a method and device which is useful in any organization, such as in companies, stores, Banks, and educational organizations, such as schools, colleges and universities.

It is another objective of the present invention to provide a device to obtain the customer feedback, which is simple and fast, and encourage more customers to leave their feedback about the service provider.

It is another object of the present invention to allow customers to provide feedback without any error while the name and image of the staff appears on the monitor. The customer, who has received several cards from different employees can ensure to provide feedback to the right person.

It is another objective of the present invention to follow customer satisfaction scores for individual employee and follow up directly from their feedback.

It is an object of the present invention to benchmark and improve customer satisfaction to give a service provider an additional insight that can guide business decisions.

It is another object of the present invention to prevent customers answering generic and redundant feedback questions.

Other objects, features, and advantages of the present invention will be readily appreciated from the following description. The description makes reference to the accompanying drawings, which are provided for illustration of the preferred embodiment. However, such embodiments do not represent the full scope of the invention.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 illustrates a customer feedback device according to the present invention;

FIG. 2 is a perspective view of the customer feedback device according to the present invention;

FIG. 3 is a perspective view of the customer feedback device according to the present invention;

FIG. 4 is a top view of the usage of the present invention in a department store located in a plurality of places to collect survey data; and

FIG. 5 is a diagram of the method of customer feedback rating and processing system.

### DETAILED DESCRIPTION OF THE DRAWINGS

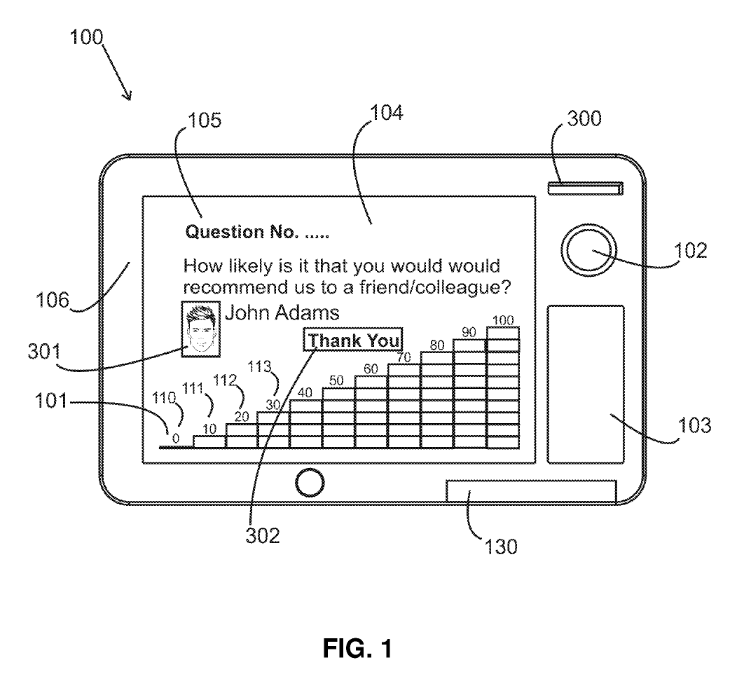

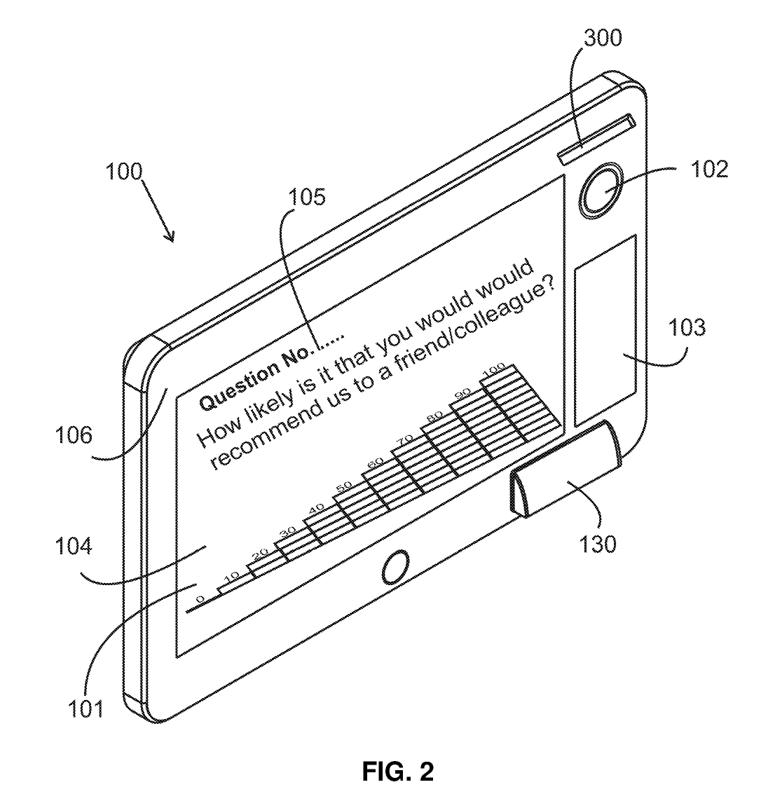

FIGS. 1 and 2 show the present device 100 for obtaining customer feedback. This device comprises of a box having a front side 106; a plurality of input areas 101,102, 103 and 300; an electronic display screen 104 to display the photo and the name of the employees 301, a survey question 105, or other phrases 302; a storage box to collect and store the cards a computer storage to store personnel related information and images; a set of survey question related to a particular product or a service; a random question generator to randomly select at least one survey question from said set of survey questions and to display said selected question on said display screen 104; a computer program to collect the customer responses to each survey question, generate a database for all responses received, and analyze all responses received, and a communication system to transmit customer feedback to a service provider.

Again referring to FIG. 1, the feedback device 100 comprises of several input areas 101, 102, 103 and 300.

The first input area 300 is a slot mounted on the feedback device 100. The slot 300 has a dimension of approximately 60 mm by 4 mm to receive a paper card or a chip card. The service provider requests the customer to rate his/her service and drop this card into the slot 300 of the feedback device 100.

The cards can be in various sizes and made of different materials. The cards include a Barcode, RFID or QR code with the name of each employee encrypted and coded thereon. Each of the employees in the company, in a store, or any service provider in an organization, receive their special cards with a barcode. The feedback device comprises of a computer storage to store the information of the individual employees along with their photos. This quality prevents of any mistake in providing feedback, when a customer refers to more than one employee and receives more than one card. The information from each barcode are stored in the databases which are assigned to the specific individual in the organization or products. The participant can response to the rating graph or specific questions and rate the employee or the product. The information is gathered with the other data such as date, time and the location of the device which the participant participates in the survey.

After the customer drops the card into the slot 300, the image and the name of the staff appears on the monitor 301 of the device. This can ensure the customer that he/she is providing feedback to the right person and prevent any mistake. A graph will then appear on the monitor 104 with a rating from zero to 100% and the customer responses to it. Regarding to the setting of the device any rating question about a special service, a special product or other options is possible. After that a thank you phrase 302 will appear on the monitor or will be heard by the microphone. Various thank you audio files or phrases can be set up on the device.

Two methods of survey encoded cards are provided in conjunction with the survey device; 1) recyclable cards, 2) disposable cards. Recyclable type cards can be re-encoded and returned to the relevant staff for re-use. Disposable cards are only for single use and after dropped into the device will be discard. In this case the resisting codes will be removed from the memory of the system. If any of the employees are on vacation, have to take their cards and the alternative employees have to use their own cards.

The present invention further has a scanning means 130 to scan the barcode that is associated to the specific employee or product. By scanning the barcode, the related information displays on the monitor and the participant can respond to the specific question and rate the product or employee. The information is gathered with the other data such as date, time and the location of the device which the participant participate in the survey.

Again as shown in FIG. 2 a case is embedded on the back of the device to collect the cards and chip cards. Whenever the capacity of the case is completed an indication on the monitor appears to discharge the device box.

A software application is installed on the rating device 100 to program all these procedures. The device 100 can be programmed to print the various types of the cards with the information thereon, by using Barcode or RFID which can be printed on paper cards to give to the clients, employees or the manager.

In this method, the employees can also leave feedback for each other. In this regard each employee receives his co-workers card and rates his/her work by dropping the card inside the rating device. This procedure is completely confidential.

The managers can also receive the feedback of the employees by providing their special encoded card to the employees. The feedback procedure will be confidential. By this method the managers can discuss different ideas to improve the company. The manager provides an encoded card, which is printed specifically for this reason, to the employees to receive their feedback for an upcoming project in the company, or for rating a new product. Whenever the employee drops the card in the feedback device, the related project which is going to be rated, will appear on the monitor. The clients or customers can be requested to rate for the special product or a service offered in the organization or the manager can ask about general policies of the company.

In this method of obtaining feedback the amount of the clients, customers or employees, who have received rating cards or chip cards but did not participate in feedback system, is predictable. When printing on the disposable cards for each employee, simply the number of the remaining cards of the same employee specifies the percentage of how many people are reluctant to participate in surveys. The number of employees or clients who received cards and did not respond can be also determined. The forgoing data is important for a manager to change the statistic of the organization and can be used daily, weekly or monthly. In this method, each customer is able to vote for an employee only once.

The second input area 101 contains of a plurality of input buttons 110,11, 112 and 113 rating by percentage from 0%-100% buttons, wherein each button 110, 11,112, and 113 representing the percentage of customer satisfaction; for the customer to provide the rating of the services or products. The input buttons 110, 11, 112 and 113 are arranged on the feedback device 100 to simply receive the customer's feedback.

The third input area 102 is a microphone to record the customer's feedback. As shown in FIGS. 1 and 2, customer provides direct feedback through a microphone. Direct feedback may be communicated between a customer and some other party or recorded, via a microphone 102.

The fourth input area 103 is a text input box to receive the customer feedback. The text input box may be a touch sensitive display such as a LCD display, electronic paper, a LED display or an electronic touch sensitive display. The input box 103 is able to display the messages in the message area and display inputs.

The fourth input area 103 may also include inputs such as a digital pen or touch screen, keyboard and the like, so that the customer can input any feedback to the service provider. This prevents to limit the customer to answer only the generic feedback questions.

The input system 101, 102, 103 and 300 allow the service providers to vary the number of the inputs depending on the displayed messages or recorded messages or ranking button input on the feedback device.

The electronic display unit 104 further is used for setting up various parameters and/or inputting operational instructions 105. Optional daily items such as question about a new product or service are displayed and the customer can use the touch screen or the plurality of hard keys to respond.

Again Referring to FIGS. 1 and 2, the device 100 further includes a scanning means 130 to scan the employees cards or the barcodes of the products and display a random questionnaire from the related survey in the display screen 104. The bar code scanner-and-reader system includes a scanner unit 130 that scans the encoded information contained in a selected bar code and transmits the information to a reader unit. The bar code scanner-and-reader includes, a bar code information input portion that scans the encoded information of a selected item; an information processing portion that decodes the bar code information; and, an information transmitter-receiver that transmits the bar code information to the receiver unit. The information is stored in a database which is related to the specific person or product and a question will be randomly conducted and displayed on display.

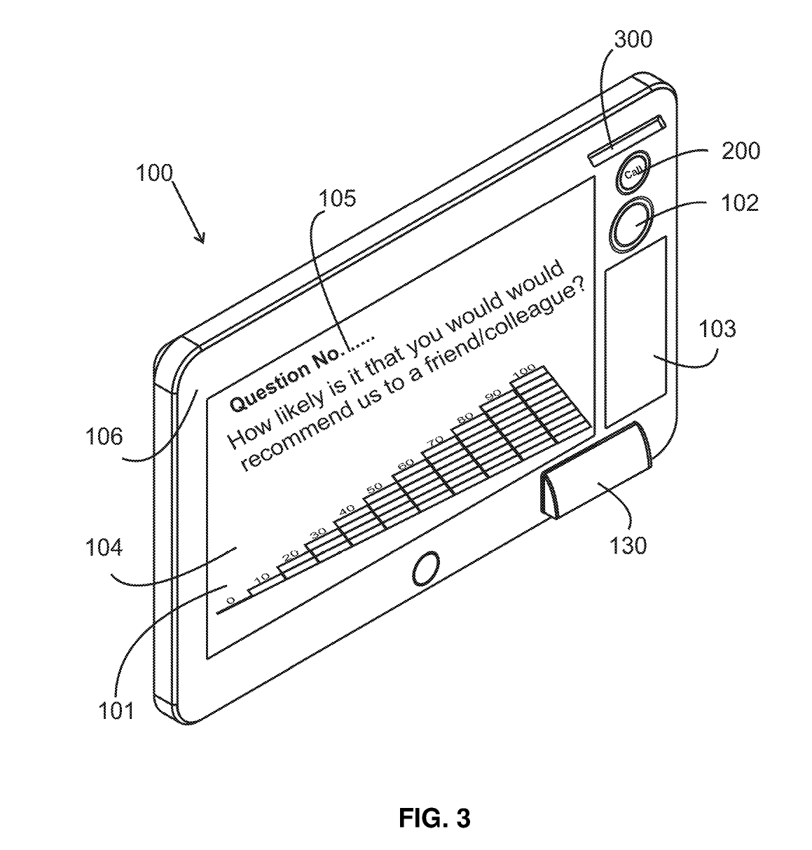

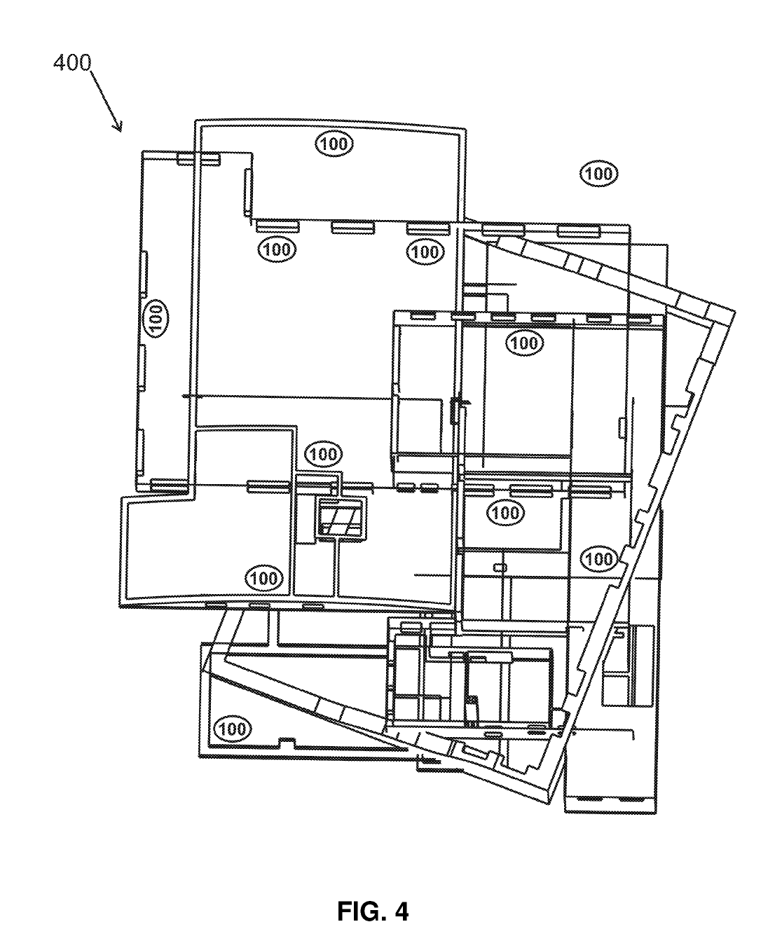

FIG. 4 shows an example of the usage of the present invention 100 in a department store 400. As shown in FIG. 3, the device 100 is located in a plurality of places to collect survey data. The device 100 can be placed near a display area for a new product to collect data related to the new product or ask a random question about the quality of a service at a specific point in the department store 400.

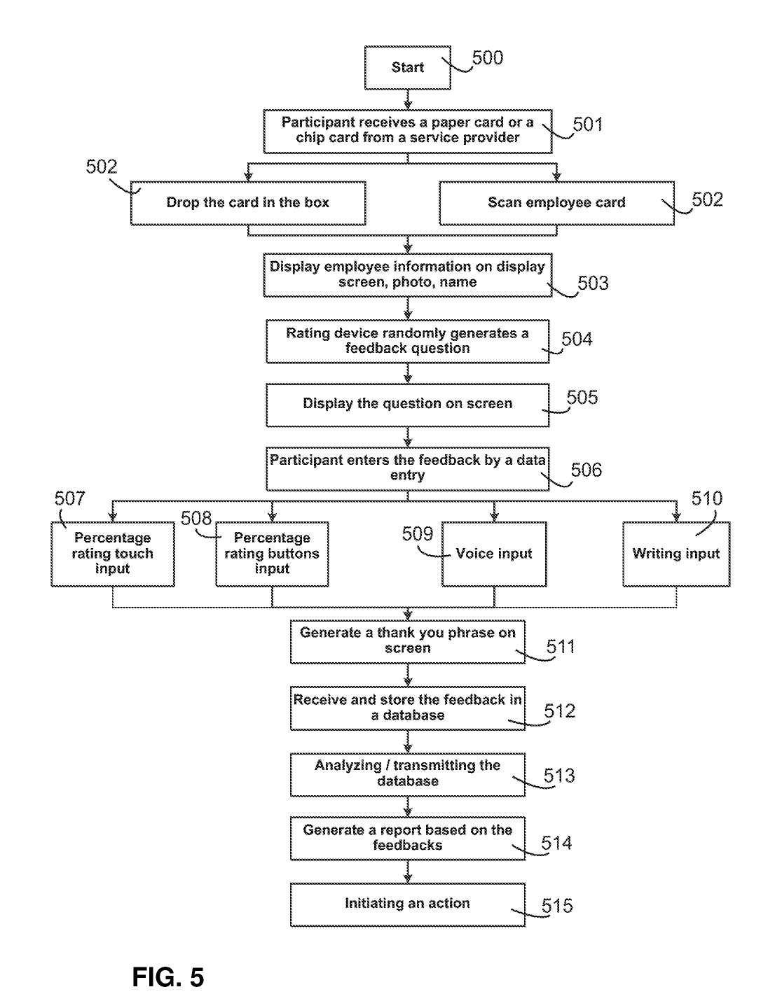

FIG. 5 is a diagram of a customer feedback system, according to the present invention. The participant in the survey being a customer to provide feedback about an employee, an employee about other employees or a manager. This method further being used by manager to obtain feedback about a service or a strategy in an organization. Participant may start to enter a rating 500 related to a service or a product.

The participant receives a card from a service provider 501. The service provider requests the customer to rate his/her service. The participant drops the card into the slot of the feedback device or scan it 502. After the customer drops the card into the slot the image and the name of the service provider appears on the monitor 503 of the device. This can ensure the customer that he/she is providing feedback to the right person and prevent any mistake.

Said device randomly generates a feedback question 504 and the question displays on the display unit 505. The participant enters the feedback about a service or product, or responds to the specific question by a data entry 506. The questions can be a free form text field for open-ended questions; a multiple choice question with pictures; free text fields as a single page form inside the survey to collect the name and address of a survey respondent; rating scale to allow the recipients to define their feedback about something on a spectrum scale or a grid to provide a simple way to ask a question with multiple items. A graph will then appear on the monitor with a rating from zero to 100% and the customer responses to it 507. Regarding to the setting of the device any rating question about a special service, a special product or other options is possible. Customer's rating may contain a percentage rating input buttons 508, a voice recorded input 509 or a written text input 510. After that a thank you phrase will appear on the monitor or will be heard by the microphone 511. Various thank you audio files or phrases can be set up on the device.

The feedback device may receive the customer rating and store it in a data storage 512. The customer rating is directly passed to a computer device for storage or store in a cloud storage system which each device is connected. The customer feedback system may receive, format, organize, process, update, modify, and/or analyze the feedback received from the customers and transmit it 513.

The feedback may simply be passed to the management of the service provider and a report will be generated based on the feedbacks 514. An action will be made to respond to the customer depending on the inputs 515.

The customer feedback system may generate a message and communicated to any of the managers for which are responsible. The generated message in response to a customer rating may be sent to a phone, cell phone, PDA, computer monitor, electronic paper, by SMS message, and/or other communication facility of the manager. All incoming messages include following information:

The comments of the customers for the employees; comments of the customers for the organization; the number of the customers which have participated in the rating; comments of the employees for each other and the number of the employees which have commented for their co-workers.

All the information after received will be set based on following: based on Employees name; based on the employees who have received the most feedbacks from their customers; according to the employees who have received the least rate of customer feedbacks, based on employees which earned the highest satisfaction of the other employees in the organization, based on employees which earned the least satisfaction of the other employees in the organization, what was opinion of the customers about organizations policies? what is the opinion of the employees about the manager?

The collected feedback data may be stored as a data structure on the feedback device or may be directly transmitted from the feedback device using wireless communication devices.

According to this method the customer may leave contact information. After a manager receives a feedback message, the manager may determine an action that needs to be taken. One advantage of the present feedback system is that the manager may receive the customer rating within moments of the customer providing the feedback. For example if a customer is not satisfied with the services provided during his/her visit or have issues with personnel's behavior, he/she can leave a feedback through microphone or writing input. With a quick communication of the feedback, the manager may be able to talk to the customer and turn a bad customer experience to a good experience.

The management department will collect the customer feedback, via a phone, cell phone, PDA, computer monitor, by SMS message, and/or other communication facility of the manager. The collected feedback is then interpreted and analyzed for a prompt response. If the rating is poor and outside certain parameters of the service provider, the management department can provide the right action as soon as possible.

For example, if a customer gave a 70-100%, the rating might consider the service or product are OK. But if the rating shows a 30-50%, it means the management department must take an action. A method of collecting customer feedback requires randomly displaying survey questions each at a time for customers and receiving the rating and continuing the steps until a predetermined number of rating are collected. After collecting customer responses to each survey question, a database will be generated for all responses and analyzed all responses and communicated feedback to the service provider.

Management department is able to contact individual customers, who left their contact information through their voice or written feedback. Management can respond to the unhappy customers and take a prompt action to prevent any cancellation of a service. Each manager in the management department may have a unique message to alert the manager of a certain customer rating.

The feedback device 100 may also be available at the point of sale. The feedback device 100 may also be placed in a plurality of other locations that a service provider may wish to gather customer input. The feedback device 100 may also be made as a weather tight device that may allow the feedback device 100 to be placed outdoors. For example, an outdoors feedback device 100 may be able to receive customer feedback in a fast food drive through for customers to rate the drive through service. The device may be made as a device to stand in the middle of a table.

In another embodiment of the present invention as shown in FIG. 3, the feedback device 100 further has a call key 200 that may use as a request to talk with a person in a store, to ask a question. When the call key 200 pushes by the customer, a location indicator in the system shows the exact location of the customer in the store, and the system automatically requests a help for the customer. A person will send to the location to answer to the customer questions.

To encourage customers to leave feedback on device, every now and then there will be a prize for a customer or employee, which will be selected like a lottery in the device and will be announced with a sound track for the award on the monitor and will be given to the winner by the manager. The type and value of the prize will be determined by the manager and is variable. This award system can be used by any of the 4 methods of the feedback system of the present invention.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A device for obtaining a customer feedback, comprising:
a. a box having a front side;
b. an electronic display screen on said front side to display the employee personal information; a survey question; an announcement or a customized quote;
c. a computer installed inside said box to store personal information of the employees; a set of survey questions related to a particular product or a service;
d. a random question generator installed in said computer to randomly select at least one survey question from said set of survey questions and to display said selected question on said display screen;
e. a plurality of inputs on said box; wherein said inputs being:
i. a card input slot;
ii. a plurality of input buttons;
iii. a microphone; and
iv. a text input display;
f. a computer program to collect the customer responses to each survey question, generate a database for all responses received, and analyze all responses received, and
g. a communication system to transmit customer feedback to a service provider.

2. The customer feedback device of claim 1, wherein said input slot receives a personal card to display the information of the employee to be rated.

3. The customer feedback device of claim 1, wherein said input buttons on said box, marked to show a predefined percentage of a customer satisfaction in response to said question.

4. The customer feedback device of claim 1, further having a customer input box to let a customer to write his/her own comment.

5. The customer feedback device of claim 1, further having a microphone for recording feedback.

6. The customer feedback device of claim 2, wherein said input slot having a dimension adapted to receive a personal card.

7. The customer feedback device of claim 6, wherein said personal card being an encoded card with the information of an employee or service provider printed thereon and being in the form of a recyclable or disposable card.

8. The customer feedback device of claim 1, wherein said device having scanning means to scan the barcode of a personal card or a product.

9. The customer feedback device of claim 1, wherein said device having a case to collect the input cards.

10. The customer feedback device of claim 4, wherein said text input box being a touch screen, or an electronic paper adapted to receive the feedback and the contact information of the customer.

11. The customer feedback device of claim 1, wherein said display screen is a LCD display or LED display or other such facility, to display selected feedback question and information.

12. The customer feedback device of claim 1, wherein said input buttons may be electronic buttons or mechanical buttons.

13. The customer feedback device of claim 1, wherein said device being a tabletop station or a wall mount or a floor mount station.

14. The customer feedback device of claim 1, wherein said communication system is wired or wireless.

15. The customer feedback device of claim 1, wherein said communication system may include any one of the following: a phone, a cell phone, a PDA, a computer monitor, an electronic paper, SMS message.

16. The customer feedback device of claim 1, wherein said computer system comprises of a plurality of software application to program for input information.

17. A method of collecting feedback comprising steps of:
a. Receiving a personal card of a first employee by a first customer, a second employee or a manager;
b. providing a personal card of a first employee by a first customer, a second customer or a manager;
c. displaying information of a first employee on display screen;
d. randomly displaying a first survey question on a survey device;
e. receiving a first rating for said first survey question from a first customer, a second employee or a manager;
f. providing a personal card of a second employee by said first customer, a third employee or a manager;
g. displaying information of a second employee on display screen
h. randomly displaying a second survey question on the survey device;
i. receiving a second rating for said second survey question from a second customer;
j. continuing steps a, b, c, d, e, f, g, h and i until a predetermined number of ratings are collected, and
k. collecting the customer or employee responses to each survey question, generating a database for all responses received, and analyzing all responses received, and communicating feedback to a manager.
